(19) United States
(12) Patent Application Publication
(10) Pub. No.: US 2014/0152769 A1
(43) Pub. Date: Jun. 5, 2014

(54) THREE-DIMENSIONAL SCANNER AND METHOD OF OPERATION

(71) Applicants: Paul Atwell, Lake Mary, FL (US); Clark H. Briggs, Deland, FL (US); Burnham Stokes, Lake Mary, FL (US); Christopher Michael Wilson, Lake Mary, FL (US)

(72) Inventors: Paul Atwell, Lake Mary, FL (US); Clark H. Briggs, Deland, FL (US); Burnham Stokes, Lake Mary, FL (US); Christopher Michael Wilson, Lake Mary, FL (US)

(21) Appl. No.: 13/705,736

(22) Filed: Dec. 5, 2012

(51) Int. Cl. H04N 13/02

(52) U.S. Cl. CPC H04N 13/0207
USPC 348/46

(57) ABSTRACT

A three-dimensional scanner is provided. The scanner includes a projector that emits a light pattern onto a surface. The light pattern includes a first region having a pair of opposing saw-tooth shaped edges and a first phase. A second region is provided in the light pattern having a pair of opposing saw-tooth shaped edges and a second phase, the second region being offset from the first region by a first phase difference. A third region is provided in the light pattern having a third pair of opposing saw-tooth shape edges and having a third phase, the third region being offset from the second region by a second phase difference. A camera is coupled to the projector and configured to receive the light pattern. A processor determines three-dimensional coordinates of at least one point on the surface from the reflected light of the first region, second region and third region.

### BACKGROUND OF THE INVENTION

The subject matter disclosed herein relates to a three-dimensional scanner and in particular to a three-dimensional scanner having a coded structured light pattern.

Three-dimensional (3D) scanners are used in a number of applications to generate three dimensional computer images of an object or to track the motion of an object or person. One type of scanner projects a structured light pattern onto a surface. This type of scanner includes a projector and a camera which are arranged in a known geometric relationship with each other. The light from the structured light pattern is reflected off of the surface and is recorded by the digital camera. Since the pattern is structured, the scanner can use triangulation methods to determine the correspondence between the projected image and the recorded image and determine the three dimensional coordinates of points on the surface. Once the coordinates of the points have been calculated, a representation of the surface may be generated.

A number of structured light patterns have been proposed for generating 3D images. Many of these patterns were generated from a series of patterns that were suitable for use with scanners that were held in a fixed position. Examples of these patterns include binary patterns and grey coding, phase shift and photometrics. Still other patterns used single slide patterns that were indexed, such as stripe indexing and grid indexing. However, with the development of portable or hand-held scanners, many of these patterns would not provide the level of resolution or accuracy desired due to the movement of the scanner relative to the object being scanned.

While existing three-dimensional scanners are suitable for their intended purposes the need for improvement remains, particularly in providing a three-dimensional scanner with a structured light pattern that provides improved performance for determining a three-dimensional coordinates of points on a surface.

### BRIEF DESCRIPTION OF THE INVENTION

According to one aspect of the invention, a three-dimensional scanner is provided. The scanner includes a projector configured to emit a light pattern onto a surface. The light pattern includes a first region having a first pair of opposing saw-tooth shaped edges, the first region having a first phase. A second region is provided in the light pattern having a second pair of opposing saw-tooth shaped edges, the second region having a second phase, the second region being offset from the first region by a first phase difference. A third region is provided in the light pattern having a third pair of opposing saw-tooth shape edges, the third region having a third phase, the third region being offset from the second region by a second phase difference. A camera is coupled to the projector and configured to receive light from the light pattern reflected from the surface. A processor is electrically coupled to the camera to determine three-dimensional coordinates of at least one point on the surface from the reflected light of the first region, second region and third region.

According to another aspect of the invention, a three-dimensional scanner is provided. The scanner includes a housing and a projector. The projector being disposed within the housing and configured to emit a light pattern having a first plurality of regions. Each of the first plurality of regions having a first pair of edges with saw-tooth shape, the first plurality of regions comprising a predetermined number of evenly spaced phases, the evenly spaced phases being offset from each other in a first direction along the length of the first plurality of regions. A digital camera is disposed within the housing and configured to receive light from the light pattern reflected off a surface. A processor is coupled for communication to the digital camera, the processor being responsive to executable computer instructions when executed on the processor for determining the three-dimensional coordinates of at least one point on the surface in response to receiving light from the light pattern.

According to yet another aspect of the invention, a method of determining three-dimensional coordinates of a point on the surface is provided. The method including emitting a light pattern from a projector, the light pattern including a first plurality of regions each having a pair of edges with a saw-tooth shape, wherein adjacent regions in the first plurality of regions have a different phase, the projector having a source plane. Light is received from the light pattern reflected off of the surface with a digital camera, the digital camera having an image plane, the digital camera and projector being spaced apart by a baseline distance. An image of the light pattern is acquired on the image plane. At least one center on the image is determined for at least one of the first plurality of regions. An image epipolar line is defined through the at least one center on the image plane. At least one image point is determined on the source plane corresponding to the at least one center. A source epipolar line is defined through that at least one image point on the source plane. The three-dimensional coordinates are determined for a least one point on a surface based at least in part on the at least one center, the at least one image point and the baseline distance.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a 3D scanner in accordance with an embodiment of the invention;

FIG. 2 is a schematic illustration of a the 3D scanner of FIG. 1;

FIG. 3 and FIG. 4 are schematic views illustrating the operation of the device of FIG. 1;

FIG. 5 and FIG. 5A are an enlarged view of a structured light pattern in accordance with an embodiment of the invention;

FIG. 6 is a structured light pattern having a trapezoidal shape outline in accordance with an embodiment of the invention; and

FIG. 7 is a structured light pattern having a square shape outline in accordance with an embodiment of the invention.

The detailed description explains embodiments of the invention, together with advantages and features, by way of example with reference to the drawings.

### DETAILED DESCRIPTION OF THE INVENTION

Three-dimensional (3D) scanners are used in a variety of applications to determine surface point coordinates and a computer image of an object. Embodiments of the present invention provide advantages in improving the resolution and accuracy of the measurements. Embodiments of the present invention provide still further advantages in providing the non-contact measurement of an object. Embodiments of the present invention provide advantages in reducing the calculation time for determining coordinates values for surface points. Embodiments of the present invention provide advantages in increasing the amount of allowable blur and providing an increased field of view. Still further embodiments of the invention provide advantages in reducing the number of lines in the pattern used to identify a surface point.

As used herein, the term “structured light” refers to a two-dimensional pattern of light projected onto a continuous area of an object that conveys information which may be used to determine coordinates of points on the object. A structured light pattern will contain at least three non-collinear pattern elements disposed within the contiguous and enclosed area. Each of the three non-collinear pattern elements conveys information which may be used to determine the point coordinates.

In general, there are two types of structured light, a coded light pattern and an uncoded light pattern. As used herein a coded light pattern is one in which the three dimensional coordinates of an illuminated surface of the object may be ascertained by the acquisition of a single image. In some cases, the projecting device may be moving relative to the object. In other words, for a coded light pattern there will be no significant temporal relationship between the projected pattern and the acquired image. Typically, a coded light pattern will contain a set of elements arranged so that at least three of the elements are non-collinear. In some cases, the set of elements may be arranged into collections of lines or pattern regions. Having at least three of the elements be non-collinear ensures that the pattern is not a simple line pattern as would be projected, for example, by a laser line scanner. As a result, the pattern elements are recognizable because of the arrangement of the elements.

In contrast, an uncoded structured light pattern as used herein is a pattern that does not ordinarily allow measurement through a single pattern when the projector is moving relative to the object. An example of an uncoded light pattern is one which requires a series of sequential patterns and thus the acquisition of a series of sequential images. Due to the temporal nature of the projection pattern and acquisition of the image, there should be no relative movement between the projector and the object.

It should be appreciated that structured light is different from light projected by a laser line probe or laser line scanner type device that generates a line of light. To the extent that laser line probes used with articulated arms today have irregularities or other aspects that may be regarded as features within the generated lines, these features are disposed in a collinear arrangement. Consequently such features within a single generated line are not considered to make the projected light into structured light.

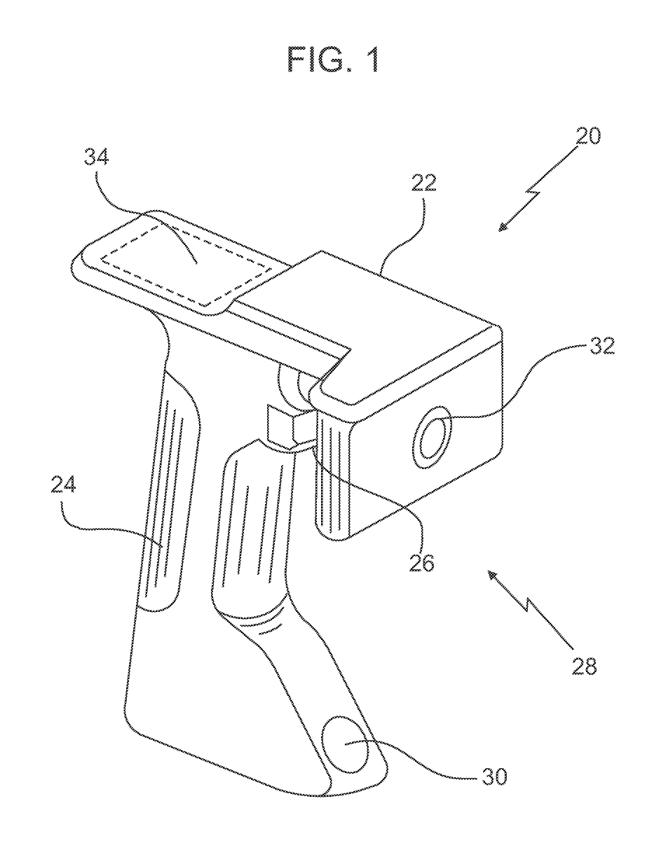

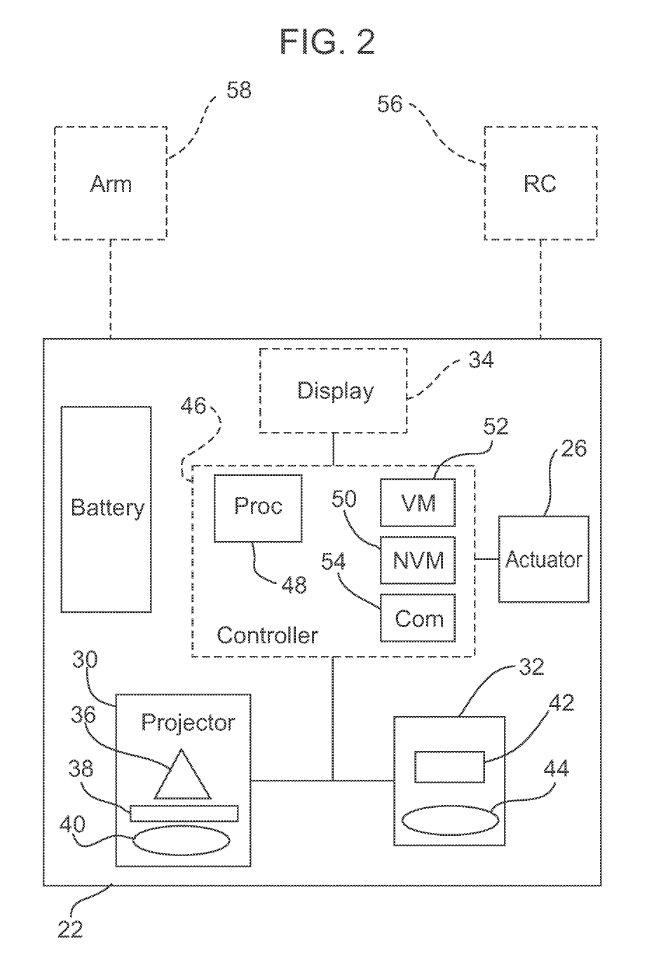

A 3D scanner 20 is shown in FIG. 1 and FIG. 2 that is sized and shaped to be portable and configured to be used by a single operator. The scanner 20 includes a housing 22 having a handle portion 24 that is sized and shaped to be gripped by the operator. One or more buttons 26 are disposed on one side of the handle 24 to allow the operator to activate the scanner 20. On a front side 28, a projector 30 and a camera 32 are disposed. The scanner 20 may also include an optional display 34 positioned to allow the operator to view an image of the scanned data as it is being acquired.

The projector 30 includes a light source 36 that illuminates a pattern generator 38. In an embodiment, the light source is visible. The light source 36 may be a laser, a superluminescent diode, an incandescent light, a light emitting diode (LED), a xenon lamp, or other suitable light emitting device. The light from the light source is directed through a pattern generator 38 to create the light pattern that is projected onto the surface being measured. In the exemplary embodiment, the pattern generator 38 is a chrome-on-glass slide having a structured pattern etched thereon. In other embodiments, the source pattern may be light reflected from or transmitted by a digital micro-mirror device (DMD) such as a digital light projector (DLP) manufactured by Texas Instruments Corporation, a liquid crystal device (LCD), or a liquid crystal on silicon (LCOS) device. Any of these devices can be used in either a transmission mode or a reflection mode. The projector 30 may further include a lens system 40 that alters the outgoing light to reproduce the desired pattern on the surface being measured.

The camera 32 includes a photosensitive sensor 42 which generates an electrical signal of digital data representing the image captured by the sensor. The sensor may be charged-coupled device (CCD) type sensor or a complementary metal-oxide-semiconductor (CMOS) type sensor for example having an array of pixels. In other embodiments, the camera may have a light field sensor, a high dynamic range system, or a quantum dot image sensor for example. The camera 32 may further include other components, such as but not limited to lens 44 and other optical devices for example. As will be discussed in more detail below, in most cases, at least one of the projector 30 and the camera 32 are arranged at an angle such that the camera and projector have substantially the same field-of-view.

The projector 30 and camera 32 are electrically coupled to a controller 46 disposed within the housing 22. The controller 46 may include one or more microprocessors 48, digital signal processors, nonvolatile memory 50, volatile member 52, communications circuits 54 and signal conditioning circuits. In one embodiment, the image processing to determine the X, Y, Z coordinate data of the point cloud representing an object is performed by the controller 46. In another embodiment images are transmitted to a remote computer 56 or a portable articulated arm coordinate measurement machine 58 (“ACCMM”) and the calculation of the coordinates is performed by the remote device.

In one embodiment, the controller 46 is configured to communicate with an external device, such as AACMM 58 or remote computer 56 for example by either a wired or wireless communications medium. Data acquired by the scanner 20 may also be stored in memory and transferred either periodically or aperiodically. The transfer may occur automatically or in response to a manual action by the operator (e.g. transferring via flash drive).

It should be appreciated that while embodiments herein refer to the scanner 20 as being a handheld device, this is for exemplary purposes and the claimed invention should not be so limited. In other embodiments, the scanner 20 may be mounted to a fixture, such as a tripod or a robot for example. In other embodiments, the scanner 20 may be stationary and the object being measured may move relative to the scanner, such as in a manufacturing inspection process or with a game controller for example.

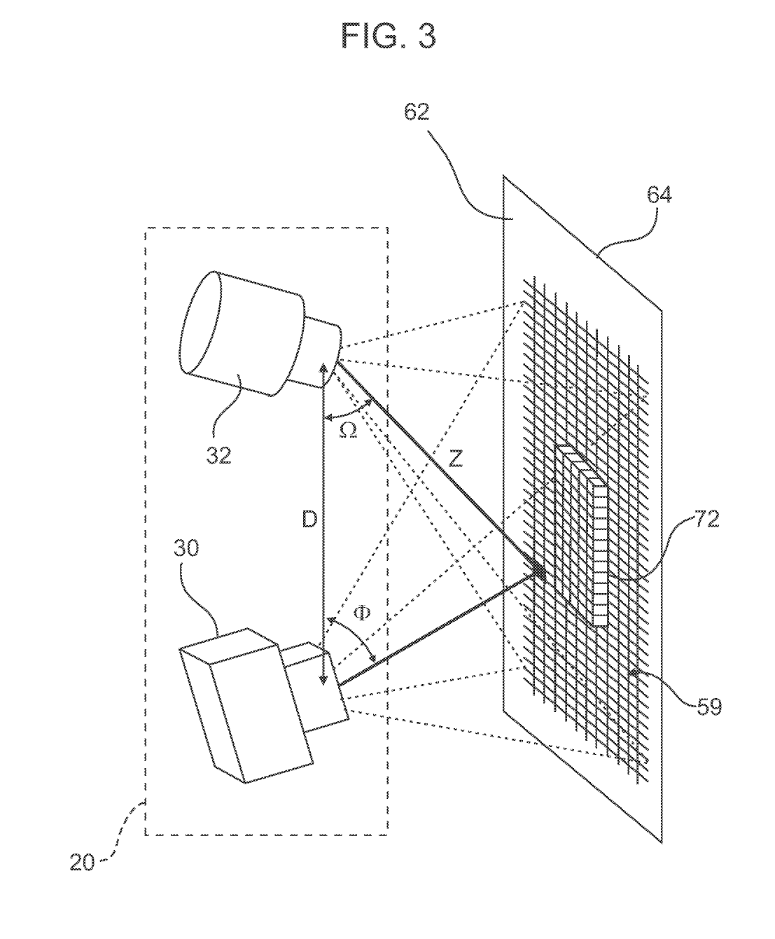

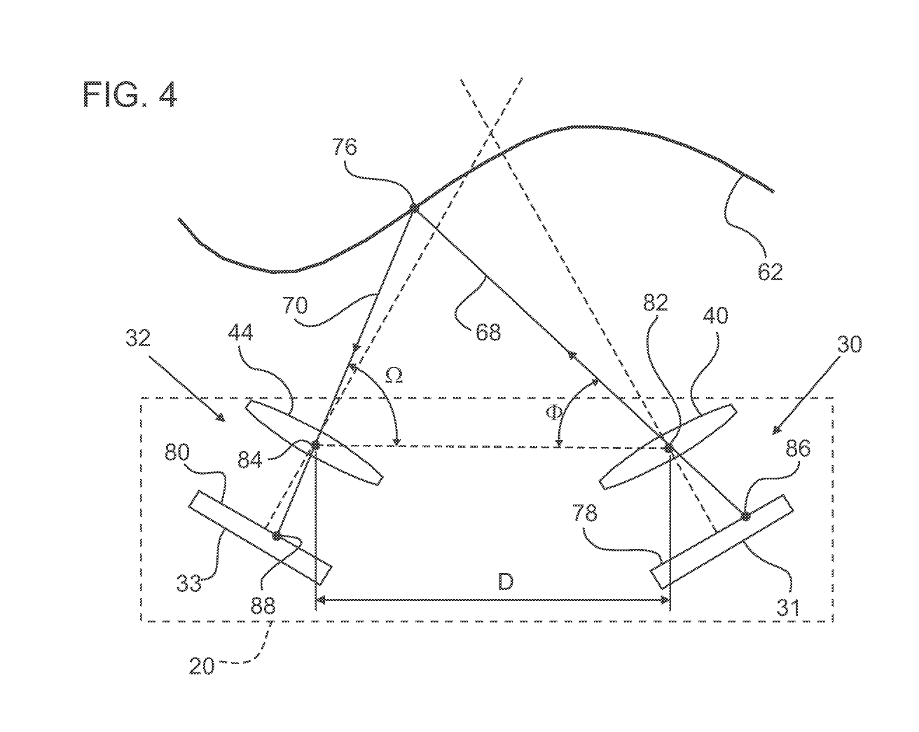

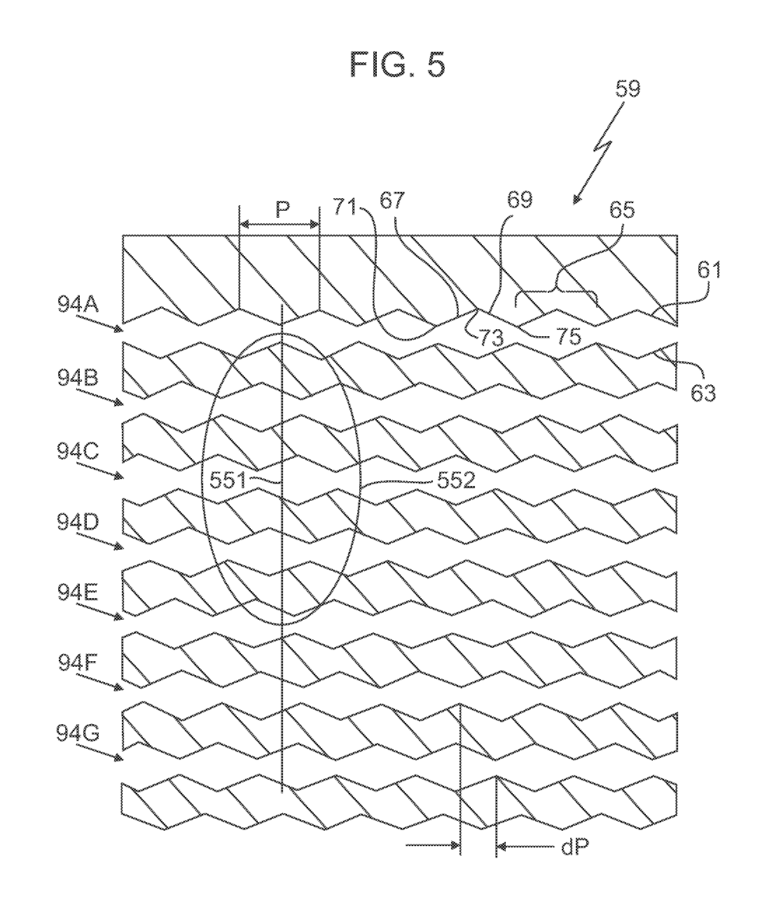

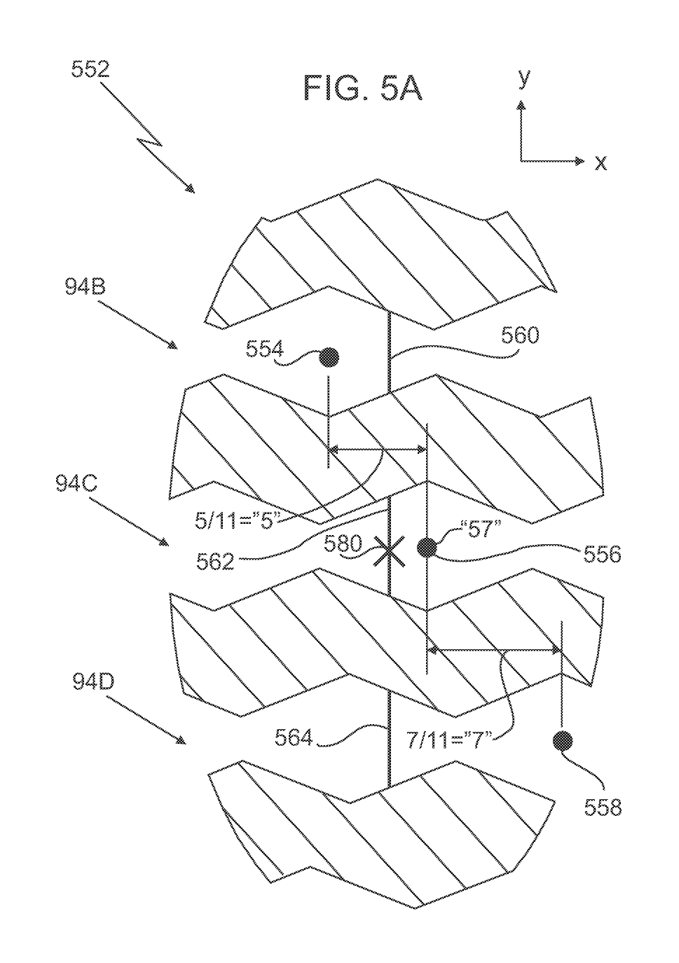

Referring now to FIG. 3 and FIG. 4, the operation of the scanner 20 will be described. The scanner 20 first emits a structured light pattern 59 with projector 30 having a projector plane 31 which projects the pattern through lens 40 onto surface 62 of the object 64. The structured light pattern 59 may include the pattern 59 shown in FIGS. 5-7. The light 68 from projector 30 is reflected from the surface 62 and the reflected light 70 is received by a photosensitive array 33 in camera 32. It should be appreciated that variations in the surface 62, such as protrusion 72 for example, create distortions in the structured light pattern when the image of the pattern is captured by the camera 32. Since the pattern is formed by structured light, it is possible in some instances for the controller 46 or the remote devices 56, 58 to determine a one to one correspondence between the pixels in the emitted pattern, such as pixel 86 for example, and the pixels in the imaged pattern, such as pixel 88 for example. This correspondence enables triangulation principles to be used to determine the coordinates of each pixel in the imaged pattern. The collection of three-dimensional coordinates of points on the surface 62 is sometimes referred to as a point cloud. By moving the scanner 20 over the surface 62 (or moving the surface 62 past the scanner 20), a point cloud may be created of the entire object 64.

To determine the coordinates of the pixel, the angle of each projected ray of light 68 intersecting the object 64 in a point 76 is known to correspond to a projection angle phi (Φ), so that Φ information is encoded into the emitted pattern. In an embodiment, the system is configured to enable the 0 value corresponding to each pixel in the imaged pattern to be ascertained. Further, an angle omega (Ω) for each pixel in the camera is known, as is the baseline distance “D” between the projector 30 and the camera 32. Since the two angles Ω, Φ and the baseline distance D between the projector 30 and camera 32 are known, the distance Z to the workpiece point 76 may be determined. This enables the three-dimensional coordinates of the surface point 72 to be determined. In a similar manner the surface points over the whole surface 62 (or any desired portion thereof).

In the exemplary embodiment, the structured light pattern 59 is a pattern shown in FIGS. 5-7 having a repeating pattern formed by sawtooth regions with a pair of opposing saw-tooth shaped edges. As explained hereinbelow, the phases of contiguous sawtooth regions may be compared to obtain a code for each collection of contiguous patterns. Such a coded pattern allows the image to be analyzed using a single acquired image.

Epipolar lines are mathematical lines formed by the intersection of epipolar planes and the source plane 78 or the image plane 80 (the plane of the camera sensor). An epipolar plane may be any plane that passes through the projector perspective center 82 and the camera perspective center 84. The epipolar lines on the source plane 78 and the image plane 80 may be parallel in some cases, but in general are not parallel. An aspect of epipolar lines is that a given epipolar line on the projector plane 78 has a corresponding epipolar line on the image plane 80.

In an embodiment, the camera 32 is arranged to make the camera optical axis perpendicular to a baseline dimension that connects the perspective centers of the camera and projector. Such an arrangement is shown in FIG. 1. In this embodiment, all of the epipolar lines on the camera image plane are mutually parallel and the camera sensor can be arranged to make the pixel columns coincide with the epipolar lines. Such an arrangement may be advantageous as it simplifies determining the phases of contiguous sawtooth regions, as explained hereinbelow.

An example of an epipolar line 551 that coincides with a pixel column of the image sensor is shown in FIG. 5. A portion 552 of the sawtooth pattern is enlarged for closer inspection in FIG. 5A. Three of the sawtooth regions 94B, 94C, and 94D are shown. The epipolar line 551 from FIG. 5 intersects the three sawtooth regions in three sawtooth segments 560, 562, and 564. Following a measurement, the collected data is evaluated to determine the width of each sawtooth segment. This process is repeated for the sawtooth segments in each of the columns. The period of a given sawtooth region in the x direction is found by noting the number of pixels between locations at which the slope of the sawtooth segment width changes from negative to positive. Three centers of sawtooth periods are labeled in FIG. 5A as 554, 556, and 558. These centers may be found by taking the midpoint between the starting and ending points of each period. Alternatively, the centers may be found by taking a centroid of each sawtooth period, as discussed further hereinbelow.

The difference in the x positions of the centers 554 and 556 is found in the example of FIG. 5A to be 5/11 of a period. The difference in the x positions of the centers 556 and 558 is found in the example to be 7/11 of a period. In an embodiment, the centermost sawtooth region 94C is then said to have a code of “57”, where the 5 comes from numerator of 5/11 and the 7 comes from the numerator of 7/11.

The center of the sawtooth segment 580 is marked with an “X”. The three-dimensional coordinates of this point are found using a method that is now described. Referencing FIG. 4, it is known that light passing from a point 76 on an object surface passes through a perspective center 84 of the camera lens and strikes the photosensitive array 33 at a position 88. The distance between the perspective center and the photosensitive array is known as a result of compensation procedures performed at the factory following fabrication of the device 20. The x and y pixel positions are therefore sufficient to determine an angle of intersection with respect to the camera optical axis, shown in FIG. 4 as a dashed line. The angle of the optical axis with respect to the baseline (that extends from point 82 to point 84) is also known from measurements performed at the factory. Hence, the angle Ω is known.

As discussed hereinabove, there is a one-to-one correspondence between epipolar lines in the camera image plane and the projector plane. The particular point on the corresponding epipolar line on the projector plane is found by finding the sawtooth region that has the code corresponding to the X point 580. In this case, that code is “57”. By selecting that portion of the projector epipolar line having a code “57”, the pixel coordinates on the projector plane can be found, which enables the finding of the angle Φ in FIG. 4. The baseline distance D is a predetermined value and is constant/fixed for a particular scanner device. Hence two angles and one side of the triangle having vertices 76, 84, 82 are known. This enables all sides and angles to be found, including the distance “Z”, which is the distance between the vertices 76 and 84. This distance, in addition to the angle Ω provides the information needed to find the three-dimensional coordinates of the point 76. The same procedure may be used to find the coordinates of all points on the surface 62. A general term for the finding three-dimensional coordinates by finding two angles and one distance is “triangulation.”

In the discussion above, a small region of a sawtooth pattern was considered in detail. In an exemplary embodiment, the structured light pattern 59 has a plurality of sawtooth regions 94 that are phase offset from each other. In the embodiment where the pattern is generated by a chrome-on-glass slide, the sawtooth segment portion is the area where light passes through the slide. Each sawtooth region 94 includes a pair of shaped edges 61, 63 that are arranged in an opposing manner from each other. Each edge 61, 63 includes a repeating pattern 65 having a first portion 67 and a second portion 69. The first portion 67 is arranged with a first end point 71 extending to a second end point 73 with along a first slope. The second portion 69 is arranged starting at the second end point 73 and extending to a third end point 75 along a second slope. In other words, the second end point 73 forms a peak in the pattern 65 for edge 61 (or a trough along edge 63). In one embodiment the slopes of portions 67, 69 are equal but opposite. It should be appreciated that the opposing edge 63 similarly includes a set of repeating (but opposite) patterns having a first portion and a second portion each having a slope. As used herein, this repeating pattern 65 is referred to as a saw-tooth shape. Therefore each sawtooth region 94 has a pair of opposing saw-tooth edges 61, 63.

The pattern 59 is arranged with a set predetermined number of sawtooth region 94 configured at a particular phase. Each sawtooth region 94 is assigned a phase number from zero to the predetermined number (e.g. 0-11). The phase lines are arranged to be evenly spaced such that the phase offset is equal to:

$$\frac{Phase Number}{Predetermined Number of Phase Lines} * Period \qquad ( 2 )$$

As used herein, the term “period” refers to the distance “P” between two adjacent peaks. In the exemplary embodiment, the pattern 59 has 11 Phase lines. Therefore, the offset for each of the lines would be:

TABLE 1

| Phase Line No. | Offset Amount |
|---|---|
| Phase 0 | Baseline |
| Phase 1 | Line offset from baseline by (1/11)*period |
| Phase 2 | Line offset from baseline by (2/11)*period |
| Phase 3 | Line offset from baseline by (3/11)*period |
| Phase 4 | Line offset from baseline by (4/11)*period |
| Phase 5 | Line offset from baseline by (5/11)*period |
| Phase 6 | Line offset from baseline by (6/11)*period |
| Phase 7 | Line offset from baseline by (7/11)*period |
| Phase 8 | Line offset from baseline by (8/11)*period |
| Phase 9 | Line offset from baseline by (9/11)*period |
| Phase 10 | Line offset from baseline by (10/11)*period |

In the exemplary embodiment, the phase line numbers are not arranged sequentially, but rather are arranged in an order such that the change in phase (the “phase difference”, e.g. Phase No. “N”−Phase No. “N−1”) will have a desired relationship. In one embodiment, the phase difference relationship is arranged such that the phase difference for a first portion 90 of the pattern 59 is an odd number, while the phase difference for a second portion 92 is an even number. For example, if sawtooth region 94E has a phase number of “10” and sawtooth region 94D has a phase number of “1”, then the phase difference from sawtooth region 94D to sawtooth region 94E is (10−1=9), an odd number. If for example sawtooth region 94E has a phase number of “8” and sawtooth region 94D has a phase number of “6”, then the change in phase from sawtooth region 94D to 94E is (8−6=2), an even number.

In each pixel column of the acquired image, sawtooth segments are identified using the slope of an intensity curve. The intensity curve is a series of grey scale values based on the intensity, where a lighter color results in a higher intensity and conversely a darker color has a lower intensity.

As the values of the intensities are determined within a column of pixels, an intensity curve may be generated. It should be appreciated that the intensity value will be low in the black portions of the pattern and will increase for pixels in the transition area at the edge of the black portion. The lowest values will be at the center of the black region. The values will continue to increase until the center of the white line and then decrease back to lower values at the transition to the subsequent black area. When the slope of the intensity curve goes from a negative to a positive, a minimum has been found. When the slope of the intensity curve goes from a positive to a negative, a maximum has been found. When two minima in the intensity curve are separated by a maxima, and the difference in intensity meets a threshold, a sawtooth region 94 is identified. In one embodiment, the threshold is used to avoid errors due to noise. A center of the each sawtooth segment may be found to sub-pixel accuracy. The width of the sawtooth region 94 is calculated by summing the number of pixels between the two minimums in the intensity curve.

In one embodiment, a sawtooth-region centroid (e.g. point 554) is determined by taking a weighted average (over optical intensity in the image plane) of all of the points in each sawtooth region. More precisely, at each position along the sawtooth segment a pixel has a y value given by y(j), where j is a pixel index, and a digital voltage readout V(j), which is very nearly proportional to the optical power that fell on that particular (j) pixel during the exposure time of the camera. The centroid is the weighted average of the positions y(j) over the voltage readouts V(j). In other words, the centroid is:

Y=yCENTROID=summation(y(j)*V(j))/summation(V(j)) (Eq. 1)

over all j values within a given sawtooth region.

In another embodiment, a midpoint of the sawtooth region 94 is used instead of a sawtooth-region centroid.

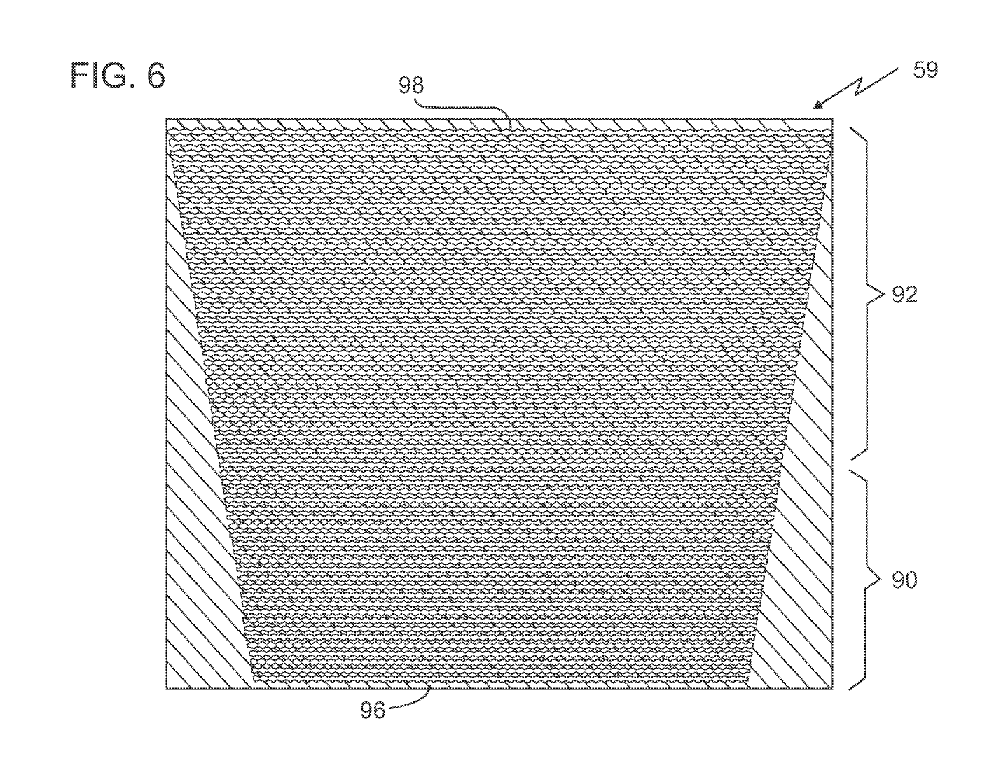

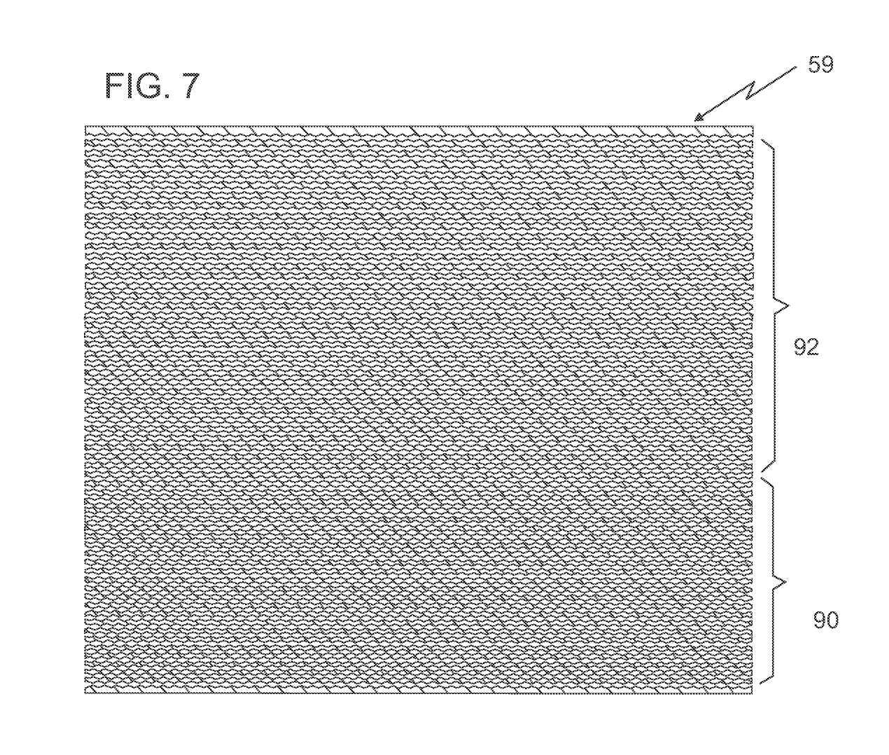

Once a sawtooth region 94 has been identified, these steps are performed again proceeding along the line (horizontally when viewed from the direction of FIG. 6 and FIG. 7) using the sawtooth region width of the sawtooth region 94 instead of intensity values to determine each sawtooth period. In this manner, the X and Y positions for the centroids of each sawtooth period (e.g. each “diamond” portion of the saw tooth pattern) may be determined. This period along the pixel rows is referred to as Pixels-Per-Phase. If the number of pixels from the “horizontal (row) centroid” of a sawtooth period to a particular sawtooth region is X, then the phase for the particular column centroid is 360°*(X/Pixels-Per-Phase). To simplify the reporting of the phase, integer values from 0 to 10 are used instead of degrees. The phase of the line may be calculated as:

(Xposition/Pixels-per-Phase)modulo(Predetermined-Number) (Eq. 2)

Where the Predetermined Number is the number of unique phase lines in the pattern. In the exemplary embodiment, the Predetermined Number is 11. The change in phase between adjacent lines may then be calculated as:

((X₂−X₁)/Pixels-per-Phase)modulo(Predetermined Number) (Eq. 3)

As used herein, the term “modulo” means to divide the quantity by the predetermined number and find the remainder.

This arrangement assigning phase numbers to sawtooth regions and determining the change in phase provides advantages in allowing the controller 46 establish a code for determining the one-to-one correspondence with the projector plane, for validation, and for avoiding errors due to noise. For example, when identifying the sawtooth region acquired by camera 32, controller 46 checks the phase difference between two sawtooth regions and it is an even number, and determines that it should be an odd number based on its location in the image, the controller 46 may determine that there is a distortion in the image which is causing an error and those lines may be discarded.

In one embodiment, each three sawtooth regions define a code based on the phase difference that is unique within the pattern. This code may then be used within the validation process to determine if the correct sawtooth regions have been identified. To establish the code, the phase difference from the first two sawtooth regions and define this as the first digit of the code. The phase difference from the second two sawtooth regions is then defined as the second digit of the code. For example, the codes for the region 94 in the exemplary embodiment would be:

TABLE 3

| Sawtooth Regions | Code | Definition |
|---|---|---|
| 94A, 94B, 94C | 35 | (3 Phase Change, 5 Phase Change) |
| 94B, 94C, 94D | 57 | (5 Phase Change, 7 Phase Change) |
| 94C, 94D, 94E | 79 | (7 Phase Change, 9 Phase Change) |
| 94D, 94E, 94F | 91 | (9 Phase Change, 1 Phase Change) |
| 94E, 94F, 94G | 15 | (1 Phase Change, 5 Phase Change) |

In the exemplary embodiment shown in FIG. 6 and FIG. 7, the light pattern 59 is comprised of 60 sawtooth regions 94. In one embodiment, each sawtooth region 94 is horizontally offset by one or more multiples of a phase amount dP from the previous sawtooth region. In other embodiments, the sawtooth region pairs are in phase with each other such that the offset by zero dP. Each sawtooth region 94 is assigned a phase number, there are 11 evenly spaced phase number sawtooth region. Each of the phase number sawtooth region is spaced based on the period as discussed herein above. The sawtooth region 94 are not arranged sequentially but as is shown in Table 2:

TABLE 2

| Region # | Phase | Phase Difference |
|---|---|---|
| 1 | 8 | |
| 2 | 0 | 3 |
| 3 | 5 | 5 |
| 4 | 1 | 7 |
| 5 | 10 | 9 |
| 6 | 0 | 1 |
| 7 | 5 | 5 |
| 8 | 3 | 9 |
| 9 | 6 | 3 |
| 10 | 2 | 7 |
| 11 | 3 | 1 |
| 12 | 10 | 7 |
| 13 | 2 | 3 |
| 14 | 0 | 9 |
| 15 | 5 | 5 |
| 16 | 6 | 1 |
| 17 | 4 | 9 |
| 18 | 2 | 9 |
| 19 | 9 | 7 |
| 20 | 5 | 7 |
| 21 | 10 | 5 |
| 22 | 4 | 5 |
| 23 | 7 | 3 |
| 24 | 10 | 3 |
| 25 | 0 | 1 |
| 26 | 1 | 1 |
| 27 | 1 | 0 |
| 28 | 5 | 4 |
| 29 | 2 | 8 |
| 30 | 1 | 10 |
| 31 | 3 | 2 |
| 32 | 9 | 6 |
| 33 | 6 | 8 |
| 34 | 6 | 0 |
| 35 | 8 | 2 |
| 36 | 1 | 4 |
| 37 | 0 | 10 |
| 38 | 4 | 4 |
| 39 | 10 | 6 |
| 40 | 10 | 0 |
| 41 | 7 | 8 |
| 42 | 9 | 2 |
| 43 | 8 | 10 |
| 44 | 3 | 6 |
| 45 | 5 | 2 |
| 46 | 2 | 8 |
| 47 | 6 | 4 |
| 48 | 6 | 0 |
| 49 | 5 | 10 |
| 50 | 4 | 10 |
| 51 | 1 | 8 |
| 52 | 9 | 8 |
| 53 | 4 | 6 |
| 54 | 10 | 6 |
| 55 | 3 | 4 |
| 56 | 7 | 4 |
| 57 | 9 | 2 |
| 58 | 0 | 2 |
| 59 | 0 | 0 |
| 60 | 0 | 0 |

As a result, the pattern 59 includes a first plurality of sawtooth regions 90 where in the phase difference is an odd number and a second plurality of sawtooth regions 92 where the phase difference is an even number. As discussed above, this arrangement provides advantages in validating the image acquired by camera 32 to detect distortions and avoid errors in determining the sawtooth region number in the acquired image. In the embodiment of FIG. 5 and FIG. 6, the first 25 sawtooth regions have a phase difference that is an odd number, while the remaining 35 sawtooth regions have a phase difference that is an even number. In one embodiment, shown in FIG. 6, the pattern 59 is arranged in a trapezoidal shape such that a first end 96 has a smaller width than a second end 98. The trapezoidal shape provides compensation to correct perspective distortions caused by the angle of the scanner 20 relative to the surface during operation. In another embodiment, such as the one shown in FIG. 7, the pattern 59 is a square shape. The shape of the projector pattern may depend on the angle of the projector with respect to the baseline.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A three-dimensional scanner comprising:
a projector configured to emit a light pattern onto a surface, the light pattern comprising:
a first region having a first pair of opposing saw-tooth shaped edges, the first region having a first phase;
a second region having a second pair of opposing saw-tooth shaped edges, the second region having a second phase, the second region being offset from the first region by a first phase difference;
a third region having a third pair of opposing saw-tooth shape edges, the third region having a third phase, the third region being offset from the second region by a second phase difference;
a camera coupled to the projector and configured to receive light from the light pattern reflected from the surface; and
a processor electrically coupled to the camera to determine three-dimensional coordinates of at least one point on the surface from a reflected light of the first region, the second region and the third region.

2. The scanner of claim 1 wherein each of the first pair of opposing saw-tooth shaped edges includes a repeating pattern, the repeating pattern having a period defined by a distance between two adjacent peaks, the first phase difference and the second phase difference being the period times one divided by a predetermined number defined by a number of different phase regions in the light pattern.

3. The scanner of claim 2 wherein the first region has a first phase number defined at least by the period and the second region has a second phase number defined at least by the period.

4. The scanner of claim 3 wherein the first phase number minus the second phase number is an odd number.

5. The scanner of claim 4 wherein the first phase number minus the second phase number is an even number.

6. The scanner of claim 3 wherein the light pattern further comprises:
a first plurality of regions on one end, each of the first plurality of regions having a pair of saw-tooth shaped edges;
a second plurality of regions arranged on an opposite end, the second plurality of regions each having a pair of saw-tooth shape edges;
wherein each of adjacent regions in the first plurality of regions having a phase relationship such that a phase number of a second adjacent segment minus a phase number of a first adjacent region is an odd number; and
wherein each of adjacent regions in the second plurality of regions having a phase relationship such that a phase number of a fourth adjacent region minus a phase number of a third adjacent region is an even number.

7. A three-dimensional scanner comprising:
a housing;
a projector disposed within the housing and configured to emit a light pattern having a first plurality of regions, each of the first plurality of regions have a first pair of edges with saw-tooth shape, the first plurality of regions comprising a predetermined number of evenly spaced phases, the evenly spaced phases being offset from each other in a first direction along a length of the first plurality of regions;
a digital camera disposed within the housing and configured to receive light from the light pattern reflected off a surface; and,
a processor coupled for communication to the digital camera, the processor being responsive to executable computer instructions when executed on the processor for determining three-dimensional coordinates of at least one point on the surface in response to receiving light from the light pattern.

8. The scanner of claim 7 wherein each of the first plurality of regions having a phase number, the first plurality of regions further comprising:
a second plurality of regions arranged on one end of the light pattern, wherein the difference of the phase number of a region and a previous region in the second plurality of regions is an odd number; and,
a third plurality of regions arranged on an opposite end of the light pattern, wherein the difference of the phase number of a region and a previous region in the third plurality of regions is an even number.

9. The scanner of claim 8 wherein the difference in phase between adjacent regions in the first plurality of regions is determined by subtracting the phase number of a first region from the phase number of a second region.

10. The scanner of claim 9 wherein when the difference in phase between the adjacent regions is a negative number, the difference in phase between the adjacent regions in the first plurality of regions is determined by subtracting the phase number of the first region from the phase number of the second region and adding the predetermined number of evenly spaced phases.

11. The scanner of claim 7 wherein the housing is sized to be carried and operated by a single person.

12. The scanner of claim 11 further comprising a display coupled to the housing and electrically coupled to the processor.

13. The scanner of claim 12 wherein the processor is further responsive to executable computer instructions for displaying the at least one point on the display.

14. The scanner of claim 8 wherein the first plurality of regions has a trapezoidal shape.

15. The scanner of claim 14 wherein the predetermined number of evenly spaced phases is equal to eleven.

16. A method of determining three-dimensional coordinates of a point on a surface, the method comprising:
emitting a light pattern from a projector, the light pattern including a first plurality of regions each having a pair of edges with a saw-tooth shape, wherein adjacent regions in the first plurality of regions have a different phase, the projector having a source plane;
receiving light from the light pattern reflected off of the surface with a digital camera, the digital camera having an image plane, the digital camera and the projector being spaced apart by a baseline distance;
acquiring an image of the light pattern on the image plane;
determining at least one center on the image plane for at least one of the first plurality of regions;
defining an image epipolar line through the at least one center on the image plane;
determining at least one image point on the source plane corresponding to the at least one center;
defining a source epipolar line through that at least one image point on the source plane; and
determining three-dimensional coordinates for a least one point on the surface based at least in part on the at least one center, the at least one image point and the baseline distance.

17. The method of claim 16 wherein each of the regions in the first plurality of regions has a phase number.

18. The method of claim 17 further comprising:
determining the phase number for each of the regions in the first plurality of regions in the image, the first plurality of regions including a first region, a second region and a third region;
determining a first phase difference between the first region and the second region;
determining a second phase difference between the second region and the third region.

19. The method of claim 18 further comprising generating a first code from the first region and the second region, the first code including the first phase difference and the second phase difference.

20. The method of claim 19 further comprising generating a plurality of codes for each three sequential regions in the first plurality of regions, wherein each code of the plurality of codes is unique within the light pattern.

21. The method of claim 18 wherein:
the first plurality of regions includes a second plurality of regions on one end and a third plurality of regions on an opposite end;
each of the regions in the second plurality of regions having a third phase difference, the third phase difference being defined as the difference between the phase number of a region and a preceding line in the second plurality of regions, the third phase difference being an odd number; and
each of the regions in the third plurality of regions having a fourth phase difference, the fourth phase difference being defined as the difference between the phase number of a region and a preceding region in the third plurality of regions, the fourth phase difference being an even number.

22. The method of claim 21 wherein when the third phase difference for a region is a negative number, the third phase difference for that region is defined as the difference between the phase number of the region and a preceding region plus a predetermined number, the predetermined number being equal to a number of different phase regions in the light pattern.

23. The method of claim 22 wherein a period of the saw-tooth shape is a distance between two adjacent peaks, difference in phase between two adjacent regions in the first plurality of regions being based on the predetermined number and the period.
